(19) United States
(12) Patent Application Publication
(10) Pub. No.: US 2005/0244175 A1
(43) Pub. Date: Nov. 3, 2005

(54) Initiating a calibration procedure in a printing device

(76) Inventor: Dennis Abramsohn, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/834,789

(22) Filed: Apr. 29, 2004

(51) Int. Cl. G03G 15/00

(52) U.S. Cl. 399/43; 101/484

(57) ABSTRACT

A method of initiating a calibration in a printing device. After a wake-up event has occurred, a printing device prints at least one page and then automatically initiates a very first calibration procedure.

### BACKGROUND OF THE INVENTION

During the course of operation of a printing device, various print parameters can drift resulting in a degradation of print quality. It can therefore be desirable to perform calibration procedures to restore print parameters to a desired state.

Calibration procedures can be performed in a number of ways. To perform some calibration procedures, for example, one or more test patterns are printed on a media (e.g., a paper, an image transfer belt, etc). A densitometer or other sensing device is then used to measure the density of the printed test patterns. These measurements are then used to set printing parameters to the desired state.

A problem can occur, however, when a calibration procedure is performed that results in one or more print parameters not being properly set as this can result in undesirable print quality.

### DESCRIPTION OF THE DRAWINGS

FIG. 1 is a high-level block diagram of a printing device;

FIG. 2 is a simplified block diagram illustrating certain aspects of a print engine;

FIG. 3 is a simplified diagram of a toner cartridge; and

FIG. 4 is a flow diagram for illustrating how a printing device may operate to automatically initiate a calibration procedure.

### DESCRIPTION OF THE INVENTON

Printing devices are often designed to operate in a low-power mode in order to reduce the printer's power consumption during periods when the printing device is inactive (i.e., when the printing device is not being used for printing) for an extended period of time.

For ease of discussion, a printing device that is presently operating in a low-power mode may be referred to herein as being in an “inactive state”. Furthermore, a printing device that is turned off may also be referred to herein as being in an “inactive state”.

A printer that is presently printing or ready to start printing without a warm-up cycle may be referred to herein as being in a “print ready state”. Many printing devices are designed to move from an inactive state to a “print ready” state upon the occurrence of certain events. For ease of discussion, such an event may be referred to herein as a “wake-up” event. Many printing devices, for example, move to a print ready state upon being turned on. For these printing devices, therefore, a wake-up event is the event of turning the printing device on. Furthermore, many of these same printing devices also are designed to move from a low-power mode to a print ready state upon receiving a print job. Thus, a wake-up event for these printing devices can also be the event of receiving a print job.

It is also noted that some printing devices can perform a calibration procedure to set parameters that control maximum printing densities. For ease of discussion, such a calibration procedure may be referred to herein as a “maximum density calibration”. These same printing devices may also perform a calibration procedure in order to set parameters that control printed halftones. For ease of discussion, such a calibration procedure may be referred to herein as a “halftone adjustment calibration”. The HP COLOR LASERJET 5500 is an example of a printing device that can perform both a maximum density calibration and a halftone adjustment calibration.

For ease of discussion, the very first calibration procedure that a printing device performs after a wake-up event has occurred may be referred to herein as a “wake-up” calibration procedure. Many printing devices operate to perform a wake-up calibration procedure during a warm-up cycle and prior to moving into a print ready state.

Construction of an Exemplary Printing Device

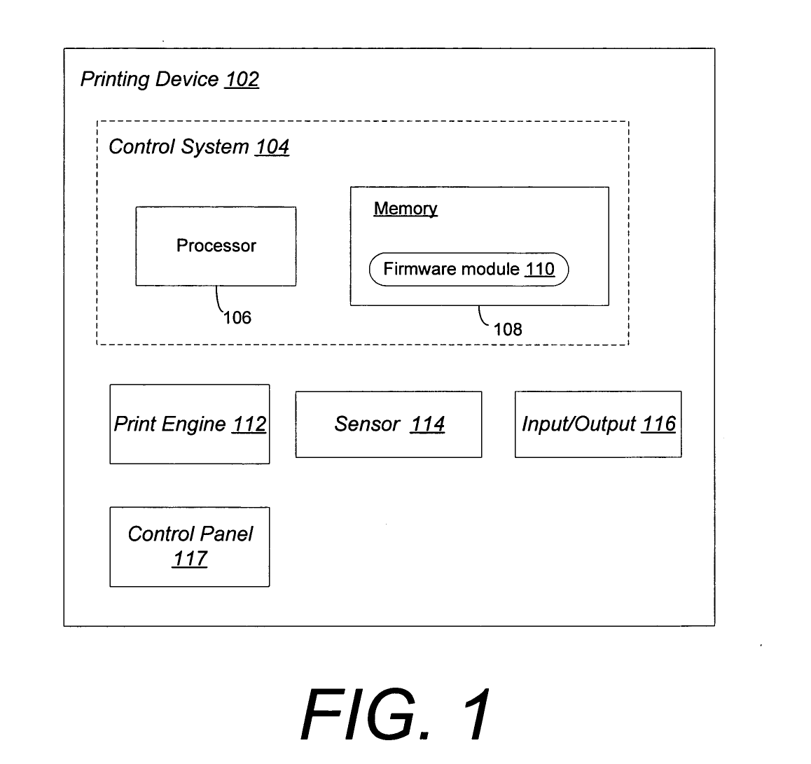

FIG. 1 is a high-level block diagram of a printing device 102 that incorporates one example embodiment of the invention. In this example, the printing device 102 is an electrophotographic (EP) printing device capable of printing in color.

As shown in FIG. 1, the printing device 102 includes a control system 104, an EP print engine 112, a sensor 114, an Input/Output (I/O) port 116 and a control panel 117. The control system 104 controls the operation of the printing device 102 and includes a processor 106 and a memory 108. The memory 108 stores one or more firmware modules 110 that direct the processor 106 to automatically initiate a wake-up calibration procedure when certain criteria are met as described below.

The sensor 114 may represent any suitable type of sensor for enabling the printing device 102 to measure the density of printed test patterns during a calibration procedure. Thus, for example, the sensor 114 may represent a densitometer, a calorimeter, a spectrophotometer, etc.

Input/Output (I/O) port 116 allows the printing device 102 to receive a print job from an external source (i.e., a personal computer) over a communication link (e.g., a network and/or a parallel cable). The control panel 117 provides a walk-up user a user interface to the printing device 102.

Construction of an Exemplary Print Engine

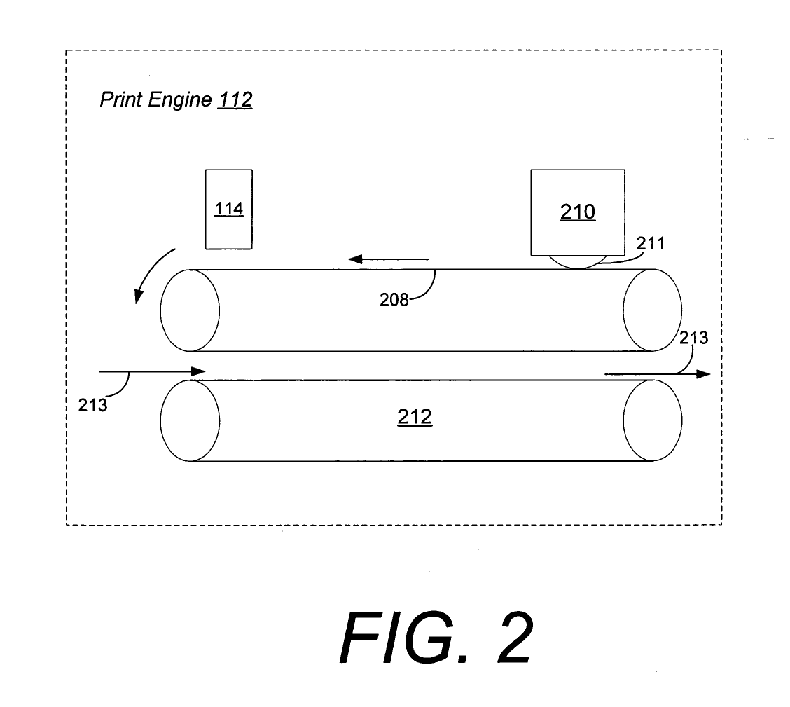

FIG. 2 is a simplified block diagram illustrating certain aspects of the print engine 112. In this example, the print engine 112 includes an image transfer belt (ITB) 208, a marking assembly 210 (for writing an image to the ITB 208) and a media transport system 212.

During a printing operation, the marking assembly 210 employs an EP process to place a color image on the ITB 208. The image may then be transferred from the ITB 208 to a media sheet which is transported through the print engine 112, by the media transport system 212, along media path 213.

As noted above, the marking assembly 210 employs an EP process to place an image on the ITB 208. Accordingly, the marking assembly 210 may include, for example:
a photoconductor 211;
a system for charging and discharging the photoconductor 211;
a laser scanning system for scanning the photoconductor so as to produce a latent image on the photoconductor 211;
One or more toner cartridges that include a separate supply of yellow (Y), magenta (M), Cyan (C), and black (K) toner.

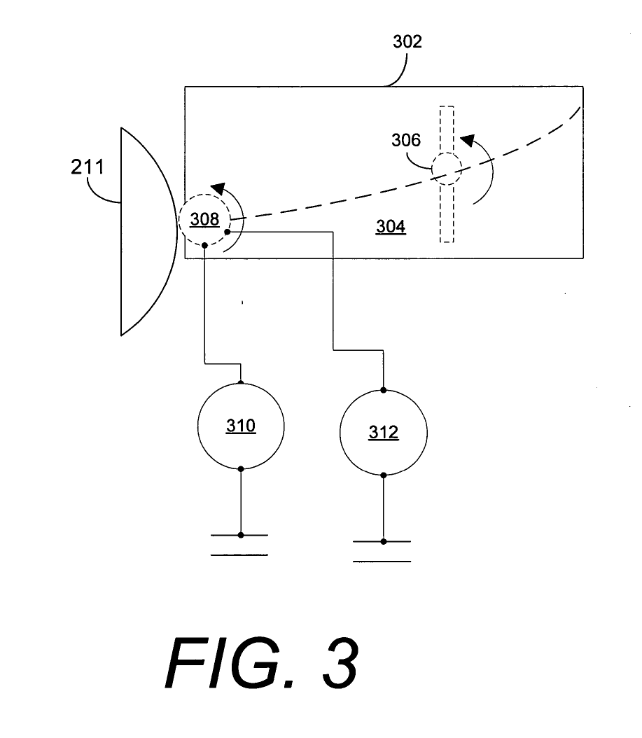

FIG. 3 is a simplified diagram illustrating one of the toner cartridges (toner cartridge 302) in the marking assembly 210. As shown, the toner cartridge 302 includes:
a supply of (C,M, Y or K) toner 304;
a toner stirring blade 306; and
a developer roller 308.

As shown, the developer roller 308 is located in proximity to the photoconductor 211 (only a portion of which is shown) and is connected to an AC source 310 and a DC source 312.

Development Step of EP Process

As understood by a person skilled in the art, the EP process typically includes a development step in order to develop, with toner, a latent image present on a photoconductor. This typically involves transferring toner from a toner supply to the photoconductor.

In the present embodiment, for example, toner transfer from the toner cartridge 302 to the photoconductor 211 is achieved by rotating the development roller 308 while applying both an AC bias (via the AC source 310) and a DC bias (via the DC source 312) to the outer surface of the developer roller 308. This results in the electrostatically charged toner 304 being electrically attracted by an electrostatic potential difference between the toner 304 and the developer roller 308.

The electrostatic potential difference causes the toner 304 to collect onto the outer surface of the developer roller 308 and then to move to the surface of the photoconductor 211 so as to develop a toned image corresponding to the latent image on the photoconductor 211. During toner transfer, the stirring blade 306 may also be rotated in order to mix the toner.

It is noted for the later discussion that under some conditions, the performance of the development step can improve the subsequent printing performance of the toner. For example, assume the toner 304 is not used for an extended period of time (e.g., eight hours). The quality of the first print generated using the toner 304 may be relatively low as a result of the toner 304 initially having a low charge level. When a development step is performed to generate printed output, the performance of the toner 304 can improve as a result of the toner being charged as well as mixed. Eventually, as the development step is repeated, the printing performance of the toner 304 stabilizes.

Calibration Procedures

In the present embodiment, the printing device 102 may implement several different types of calibration procedures in order to set various printing parameters. For example, the printing device 102 can perform a maximum printing density calibration as well as a halftone printing density calibration. In each of these procedures, test patches are printed on the image transfer belt 208 and the sensor 114 is used to measure the density of each printed test patch. The sensor measurements are then compared to target values. Based upon the comparisons, various control parameters are set.

Initiation of Calibration Procedure

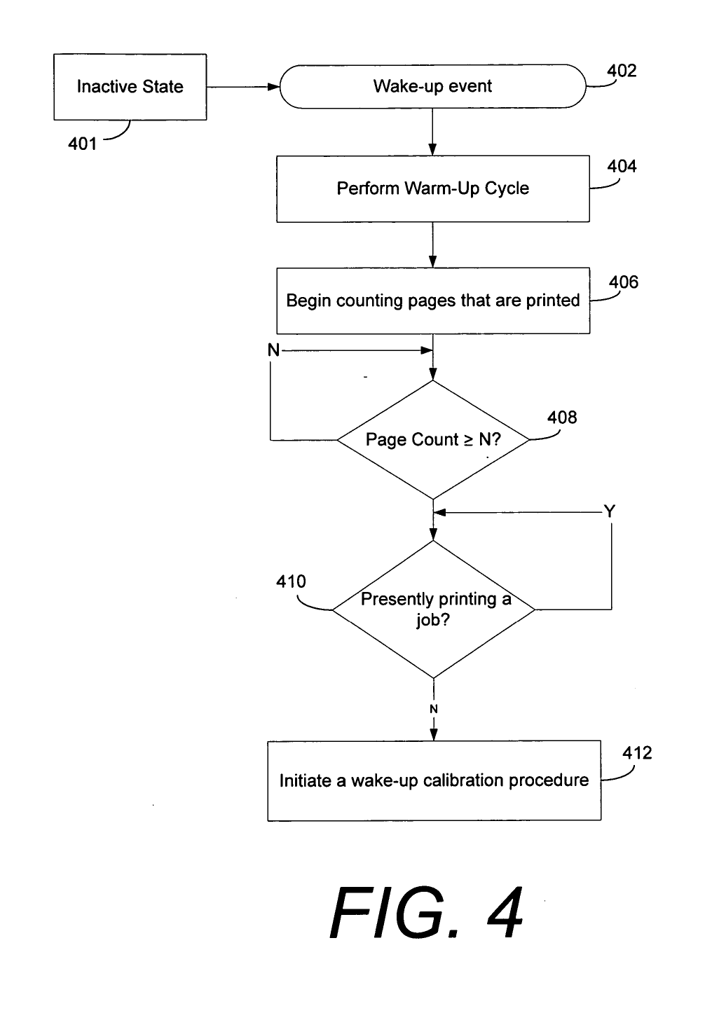

FIG. 4 is a flow diagram for illustrating how the printing device 102 may operate to automatically initiate a calibration procedure. Referring now to FIG. 4, the printing device 102, presently in an inactive state (block 401), experiences a wake-up event (block 402).

Thus, for example, at block 401 the printing device 102 may be turned off or in a low power mode. In the case wherein the printing device is turned off, the wake-up event may be the event of turning the printing device 102 on. In the case wherein the printing device 102 is presently in a low power mode, the wake-up event may be the printing device 102 receiving a print job.

In response to the wake-up event, the printing device 102 proceeds to perform a warm-up cycle (block 404). This results in the printing device 102 moving from the inactive state to a print ready state.

At block 406, the printing device 102 counts the pages that are printed since the occurrence of the wake-up event. At block 408 and block 410, the printing device 102 operates to determine when the following criteria are satisfied:
Criteria #1: The printing device 102 has printed at least a pre-determined number (N) of pages since the occurrence of the wake-up event; and
Criteria #2: The printing device is not presently printing a job.

Once the above two criteria are satisfied, the printing device 102 responds to this condition by automatically initiating a wake-up calibration procedure (block 412). The printing device may initiate, for example, a maximum density calibration procedure or a halftone density calibration procedure or both at block 412.

It is noted that performing a wake-up calibration procedure after a threshold number of pages are printed can be advantageous for a number of reasons. For example, assume the printing device 102 has not been used prior to the wake-up event for an extended period of time (e.g., eight hours). Printing pages prior to performing a wake-up calibration can improve, as well as stabilize, the printing performance of the toner supplies. As a result, the accuracy of the wake-up calibration can be improved.

It is further noted that the pre-determined number (N) of pages at block 408 may be selected with the following goals in mind:
Goal #1: The toner in each supply is adequately conditioned prior to performing the wake-up calibration; and
Goal #2: A wake-up calibration as soon as the toner in each supply is adequately conditioned.

Thus, for example, if goal #1 can be achieved with a reasonable degree of certainty after fifty or more pages are printed, the value of N may be set to fifty (as opposed to a higher number) so that the wake-up calibration is performed as soon as the toner in each supply is adequately conditioned and printing performance stabilizes.

### Other Embodiments

It is noted that in other embodiments, the printing device 102 may automatically initiate a wake-up calibration when different or additional criteria are met. The printing device 102 may initiate a wake-up calibration based upon the number of times the developer roller 308 rotates. According to one embodiment, for example, the printing device 102 initiates a wake-up calibration in response to the developer roller 308 rotating a threshold number of times after the occurrence of a wake-up event.

In yet another alternative, the printing device 102 initiates a wake-up calibration only after all the following criteria are satisfied:
Criteria #1: At least one page is printed following an occurrence of a wake-up event;
Criteria #2: Each developer roller of each toner supply has rotated at least a threshold number of times following the occurrence of the wake-up event; and
Criteria # 3: The printing device is not presently processing a job.

Note that criteria #2 would help ensure that each of the C, M, Y and K toner supplies was indeed used for printing and thereby conditioned prior to performing the wake-up calibration procedure.

It is further noted that in some embodiments a user may direct the printing device 102 to initiate a calibration procedure at any time after a wake-up event has occurred. For example, a user may initiate a wake-up calibration by inputting the appropriate request via the printer control panel 117.

It is further noted that the present invention may be embodied in the form of a “computer-readable medium”. As used herein, the phrase “computer readable medium” can refer to any medium that can contain, store or propagate computer executable instructions. Thus, in this document, the phrase “computer-readable medium” may refer to a medium such as an optical storage device (e.g., a CD ROM) or a magnetic storage device (e.g., a magnetic tape). The phrase “computer-readable medium” may also refer to signals that are used to propagate the computer executable instructions over a network or a network system, such as the Public Internet.

Thus, a memory component (e.g., memory 108) that stores computer executable instructions (e.g., firmware module 110) may represent an embodiment of the invention. Furthermore, signals used to propagate the firmware over a communication link (e.g. an intranet, Public Internet, etc) may also represent an embodiment of the invention.

Although several specific embodiments of the invention have been described and illustrated, the invention is not to be limited to specific forms or arrangements of parts so described and illustrated. The invention is limited only by the claims and the equivalents thereof.

1. In a printing device a method of initiating a calibration, comprising:
(a) after a wake-up event has occurred, printing at least one page;
(b) automatically initiating a very first calibration procedure after the occurrence of the wake-up event; and
(c) wherein act (b) is performed after the at least one page is printed.

2. The method of claim 1, wherein the calibration procedure includes a halftone adjustment calibration.

3. The method of claim 1, wherein the calibration procedure includes a maximum density calibration.

4. The method of claim 1, wherein act (b) is performed only after the printing device prints at least a pre-determined number of pages following the occurrence of the wake-up event.

5. The method of claim 4, wherein the pre-determined number of pages is between one and fifty.

6. The method of claim 1, wherein the printing device is an electrophotographic printing device.

7. The method of claim 1, wherein act (b) is performed once the following criteria are met:
(i) the printing device has printed at least a pre-determined number of pages following the occurrence of the wake-up event; and
(ii) the printing device is presently not processing a print job.

8. The method of claim 1, wherein the printing device is in a low power mode of operation when the wake-up event occurs and the wake-up event is the printing device receiving a print job.

9. The method of claim of claim 1, wherein the printing device is turned off when the wake-up event occurs and the wake-up event is turning the printing device on.

10. The method of claim 1, wherein the printing device includes a toner supply having a rotatable developer roller and wherein act (b) is performed only after: (i) the at least one page is printed and (ii) the developer roller rotates at least a threshold number of times following the occurrence of the wake-up event.

11. In a printing device having a low-power mode of operation and requiring a warm-up cycle to move from the low-power mode to a print ready mode, a method comprising:
(a) while operating in the low-power mode, receiving a print job that describes a first number of pages to be printed;
(b) in response to the print job, performing a warm-up cycle to move from the low-power mode to the print ready mode;
(c) printing the print job on the first number of pages;
(d) if the value of the first number is above a threshold number, then automatically initiating a printer calibration procedure after printing the job; and
(e) wherein the printer calibration initiated by act (d) is the very first printer calibration performed since the printing device received the print job.

12. The method of claim 11, further comprising:
(f) if the first number is below the threshold number, then waiting to initiate the calibration until the printing device has at least printed the threshold number of pages.

13. The method of claim 12, wherein the printing device is an EP printing device.

14. The method of claim 12, wherein the calibration procedure establishes how the printing device will print specific half-tones in an image.

15. The method of claim 12, wherein the calibration procedure is a maximum density calibration.

16. An EP printing device, comprising:
(a) a laser print engine;
(b) a control system operable to initiate a procedure to calibrate the operation of the laser print engine;
(c) wherein the control system is operable to initiate the procedure upon receiving a specific request to do so from a user; and
(d) wherein the control system is operable to automatically initiate the procedure after the printing device is turned on, but only after the laser print engine first prints at least a threshold number of pages.

17. The EP printing device of claim 16, wherein the control system further operates to automatically initiate the procedure after the printing device moves from a low power mode to a print ready mode, but only after the laser print engine prints at least a threshold number of pages.

18. An EP printing device, comprising:
(a) means for printing at least one page;
(b) means for automatically initiating a very first calibration procedure in response to the printing means printing at least a pre-determined number of pages after an occurrence of a wake-up event.

19. The EP printing device of claim 18, wherein the wake-up event is a power on event.

20. The EP printing device of claim 18, wherein the wake-up event is the event of receiving a print job when the printing device is operating in a low power mode.

21. The EP printing device of claim 18, wherein the very first calibration procedure includes a halftone adjustment calibration.

22. The EP printing device of claim 18, wherein the very first calibration procedure includes a maximum density calibration.

23. One or more computer-readable media comprising computer executable instructions that, when executed, direct a printing device to:
automatically initiate a wake-up calibration procedure after the printing device experiences a wake-up event but only after the printing device prints at least one page.

24. The one or more computer-readable media of claim 23 wherein the wake-up calibration includes a halftone adjustment calibration or a maximum density calibration.

25. The one or more computer readable medium of claim 23, wherein the computer executable instructions automatically initiates a wake-up calibration procedure only until the printing device prints at least a threshold number of pages following an occurrence of a wake-up event.

26. In an EP printing device including a plurality of toner supplies each including a developer roller, a method of initiating a calibration, comprising:
(a) automatically initiating a very first calibration procedure after an occurrence of a wake-up event; and
(b) wherein act (a) is performed only after the following criteria are satisfied:
(i) at least one page is printed following the occurrence of the wake-up event;
(ii) each developer roller of each toner supply has rotated at least a threshold number of times following the occurrence of the wake-up event; and
(iii) the printing device is not presently processing a job.
